(19) United States
(12) Patent Application Publication
(10) Pub. No.: US 2008/0002751 A1
(43) Pub. Date: Jan. 3, 2008

(54) High damage threshold Q-switched CO2 laser

(76) Inventors: Gongxue Hua, Unionville, CT (US); Vernon Seguin, Windsor, CT (US); Leon A. Newman, Glastonbury, CT (US); Eric R. Mueller, West Suffield, CT (US)

Correspondence Address: STALLMAN & POLLOCK LLP, 353 SACRAMENTO STREET, SUITE 2200, SAN FRANCISCO, CA, 94111, US

(21) Appl. No.: 11/481,887

(22) Filed: Jul. 6, 2006

Related U.S. Application Data
(60) Provisional application No. 60/706,973, filed on Aug. 10, 2005.

(51) Int. Cl. H01S 3/11; H01S 3/22

(52) U.S. Cl. 372/55; 372/10

(57) ABSTRACT

A thin film polarizer (TFP) and a half-wave CdTe electro-optical crystal are utilized to achieve a higher damage threshold in Q-switching CO₂ lasers for material processing applications. Half-wave CdTe electro-optical modulators can be used without the arcing and corona problems typically associated with the higher drive voltage by placing low dielectric constant insulators (such as BeO) around the CdTe crystal. Doubling the voltage placed across a CdTe crystal enables the crystal to function as a half-wave phase retarder EO switch with the same dimensions as a crystal functioning as a quarter-wave EO modulator. These half-wave EO switches can be used with TFPs to shape the output pulses, as well as to direct alternate pulses of repetitively pulsed super pulsed slab lasers to alternate scanners, thereby doubling the output of laser hole drilling systems.

### RELATED APPLICATION

This application claims the benefit of U.S. Provisional Application No. 60/706,973, filed on Aug. 10, 2005, by Hua et al., and titled “High Damage Threshold Q-Switched CO₂ Laser.” U.S. Provisional Application No. 60/706,973 is hereby incorporated by reference herein in its entirety.

### TECHNICAL FIELD OF THE INVENTION

The present invention relates to high intensity laser systems, such as Q-switched CO₂ laser systems.

### BACKGROUND

Lasers, such as Q-switched CO₂ lasers, have many material processing applications, such as hole drilling, scribing, cutting, marking and engraving of selected metals, plastics, glasses and ceramics materials. The manufacturers of systems utilizing these lasers have a continuing desire to use higher laser pulse energies, average powers and peak powers in order to increase the processing speed of their systems.

Higher CO₂ Q-switched waveguide laser pulse energies and powers are obtainable through a number of approaches, such as utilization of longer waveguide lengths, increasing the number of waveguide foldings, increasing the power into the discharge, or using a material such as a BeO ceramic for superior cooling, such as is disclosed in U.S. Pat. No. 7,046,709, issued on May 16, 2006, which is hereby incorporated herein by reference.

Attempting to fill such higher Q-switched pulse power/energies needs requires overcoming optical damaging effects of the optical components within the laser cavity. It is well known that the first laser cavity component that suffers damage is the anti-reflecting thin film on the CdTe electro-optical (EO) crystal that is used as an optical switch for the Q-switching process. The optical damage threshold of the CdTe EO switch can be raised to a sufficiently high level, such as is disclosed in U.S. Pat. No. 5,680,412, issued on Oct. 21, 1997, which is hereby incorporated herein by reference, such that damaging of the thin film is no longer a problem at the pulse energy/power levels of interest. The next inter-cavity optical component that is known to be damaged as the Q-switched lasers pulsed energy, average power and peak power are increased is the thin films of the reflective phase retarder (RPR) that is used as part of the Q-switching process in Q-switched/cavity dumped lasers, such as is described in U.S. Pat. No. 6,697,408, issued on Feb. 24, 2004, which is hereby incorporated herein by reference. The '408 patent discloses a quarter-wave CdTe EO switch used in conjunction with the RPR or a quarter wave phase-retarder. The quarter wave phase-retarder or the RPR provides a desirable ¼ wave polarization bias in the Q-switched laser. This is possible in CO₂ wave guide lasers because the output of the wave-guide laser is polarized with the optical electric field parallel to the surfaces of the metal electrodes, one of which is in direct contact with the laser discharge. Such an optical bias eliminates the need of having the EO switch provide the polarization bias by maintaining a sustaining voltage applied across the CdTe crystal, in order to prevent the laser from oscillating and to build up a larger over-population in the upper level of the CO₂ molecule for the generation of a Q-switched pulse.

As discussed in the '408 patent, maintaining a voltage on the CdTe crystal over a period of time is undesirable for a number of reasons. Consequently, a ¼ wave polarization bias element that has a higher damage threshold than a RPR is needed to further raise the optical damage threshold of CO₂ Q-switched lasers as the pulse energy, peak power and/or average output power is increased.

An example of such a higher threshold optical damage component is a Fresnel Rhomb achromatic retarder fabricated from ZnSe. A major disadvantage of a Fresnel Rhomb, however, is that it has a relatively long optical path length (i.e., approximately 1 inch) such that even the small optical absorption present (i.e., less than 0.00005/cm at 10.6 microns) in the ZnSe leads to poor laser beam quality arising from thermal lensing. Increased pointing variations also occur with increased laser power. Further, the beam axis off-set caused by the folded optical path within the Fresnel Rhomb makes it difficult to align the laser cavity, thereby increasing the manufacturing cost. The relatively long path length the laser beams travels through the ZnSe Fresnel Rhomb makes the stress birefringence a problem in mechanically holding the Fresnel Rhomb without causing laser beam distortion.

The failure rate of the RPR placed within Q-switched CO₂ lasers has been found to be approximately 2.7 times higher than for coated copper mirrors or anti-reflecting coatings deposited on the outside surfaces of the ZnSe windows, sandwiching the CdTe crystal, used in the Q-switched CO₂ laser. No failures of thin film polarizer (TFP) have been experienced in a sampling of thirty Q-switched lasers. Consequently, finding a Q-switching approach for CO₂ lasers that utilizes TFP instead of RPR's or a Fresnel Rhomb would be beneficial.

### BRIEF DESCRIPTION OF THE DRAWINGS

FIGS. 1A-1F provide a series of drawings illustrating a laser device that can be used in accordance with an embodiment of the present invention.

FIG. 2 is a plot showing oscilloscope traces of high voltage applied to an EO modulator and an emitted CO₂ Q-switched pulse.

FIGS. 3A-3C provide a series of timing sequences for RF, high voltage, and laser pulse timing in accordance with an embodiment of the present invention.

FIG. 4 is a drawing illustrating Q-switched operation of a system that includes two ZnSe Brewster angled polarizers sandwiching a half-wave CdTe EO modulator in accordance with an embodiment of the present invention.

### DETAILED DESCRIPTION OF THE INVENTION

Systems and methods in accordance with various embodiments of the present invention can overcome the above-discussed and other deficiencies in existing Q-switched laser devices and systems. In one such embodiment, a thin film polarizer (TFP) and a half-wavelength CdTe electro-optical (EO) crystal are utilized to achieve a higher damage threshold in Q-switching CO₂ lasers for material processing applications.

As discussed above, thin-film polarizers (TFPs) typically have a much higher optical damage threshold than a reflective phase retarder (RPR) and a Fresnel Rhomb, and can provide beam qualities that are superior to those produced using a Fresnel Rhomb when placed inside the optical cavity of a Q-switched CO₂ laser. CdTe EO modulators, also referred to as switches, have been found to also have a higher optical damage threshold when placed inside a Q-switched CO₂ laser optical cavity, such as by sandwiching the CdTe crystal between two ZnSe windows, as described in the above-referenced '412 patent. Both of these components are utilized within the Q-switched/cavity dumped laser described in the above-referenced '408 patent, as well as within the Q-switched laser described in U.S. Pat. No. 6,784,399, issued on Aug. 31, 2004, which is hereby incorporated herein by reference, and have been found not to experience excessive damage at the optical intensities of interest when compared with the RPR component.

Half-wave CdTe EO modulators have not been used in CO₂ Q-switching applications, primarily due to arcing and corona discharge problems associated with the higher voltage necessary to drive the half-wave crystal than needed to drive quarter-wave EO crystals. Arcing and the generation of corona discharges can be prevented from occurring in CdTe EO modulator modules (when subjected up to 6000 volts across 5 mm of CdTe) by placing low dielectric constant insulators (such as BeO, which is also a good thermal conductor) around the CdTe crystal as per the teaching of U.S. Patent Publication No. 2006/0007966, published on Jan. 12, 2006, entitled “Electro-Optical Modulator Module For CO₂ Laser Q-switching, Mode-Locking And Cavity Dumping,” hereby incorporated herein by reference. Using these insulators enables the doubling of the voltage placed across a CdTe crystal, which was not previously possible. This doubled voltage capability enables a CdTe crystal to function as a half-wave phase retarder EO switch with the same crystal dimensions as for a CdTe functioning as a quarter-wave CdTe EO modulator, thereby avoiding the need for an RPR or a Rhomb. Typical dimensions of an exemplary quarter-wave CdTe EO phase retarder are 5 mm×5 mm×50 mm, with a typical required voltage being approximately 2.6K Volts. For the same size crystal, the voltage required across the CdTe crystal to function as a half-wave EO phase retarder is approximately 5.2K Volt.

The ability to use a half-wave CdTe modulator at 5.2 KV without causing arcing has had an impact on other CO₂ laser applications. For example, half-wave EO switches can be used with TFPs to shape the output pulses, as well as to direct alternate pulses of repetitively pulsed super pulsed slab lasers to alternate scanners, thereby doubling the output of laser hole drilling systems.

The fact that the size of a half-wave CdTe EO crystal can be the same as a quarter-wave CdTe EO crystal in these applications is important from a cost, crystal quality, and availability stand point, helping the approach to be viable in a commercial Q-switched CO₂ laser for material working applications. Proper design of a dielectric insulator placed around the CdTe crystal can further reduce the crystal length by increasing the voltage beyond 5.2K Volts across the crystal. Since CdTe crystals are expensive and difficult to grow, the use of short crystals can be important from a cost standpoint.

The placement of two crossed TFPs, one on each end of a half-wave CdTe EO switch, and the placement of such a TFP/CdTe EO switch/TFP module within a waveguide CO₂ laser, can provide a unique, high optical damage threshold Q-switching EO module that is cost effective and provides high reliability. Two crossed TFPs can be preferable instead of one TFP for various systems, due to the high gain that exists in laser Q-switching operation. The high gain occurs during the high optical loss portion of the Q-switched process that builds up the large over-population of the upper CO₂ molecule laser level. Under high gain conditions, it is not unusual for the polarization of the CO₂ to find a way to oscillate in a different polarization than the normal polarization, where the electric field is parallel to the flat surfaces of the metal electrodes.

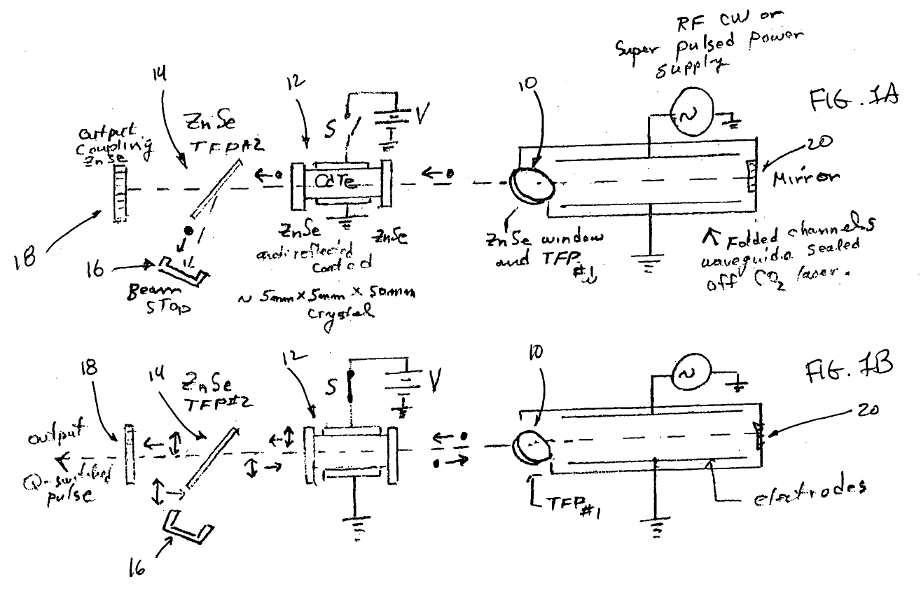

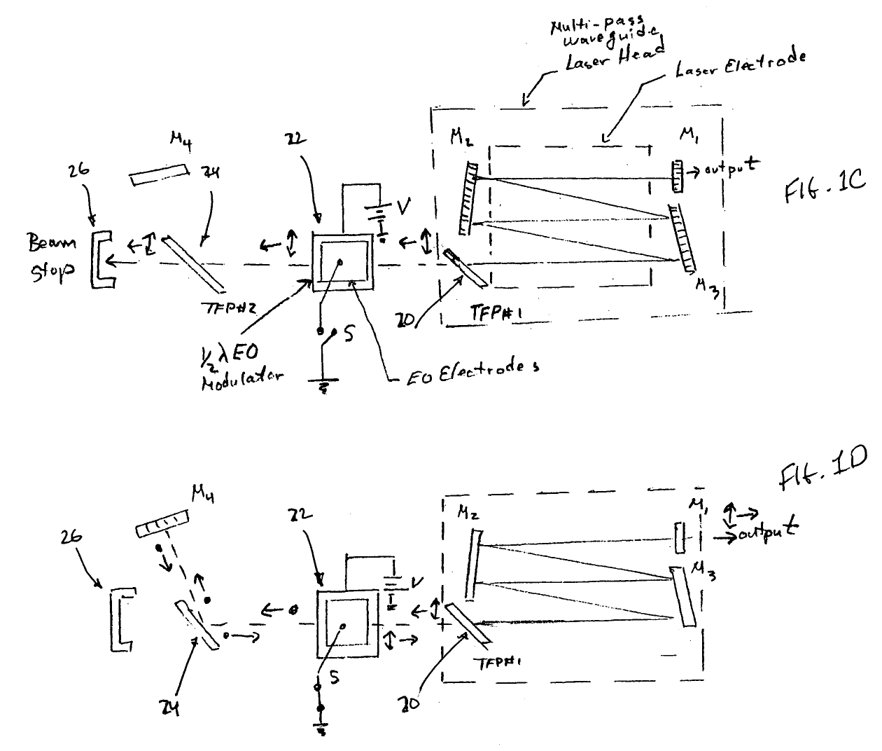

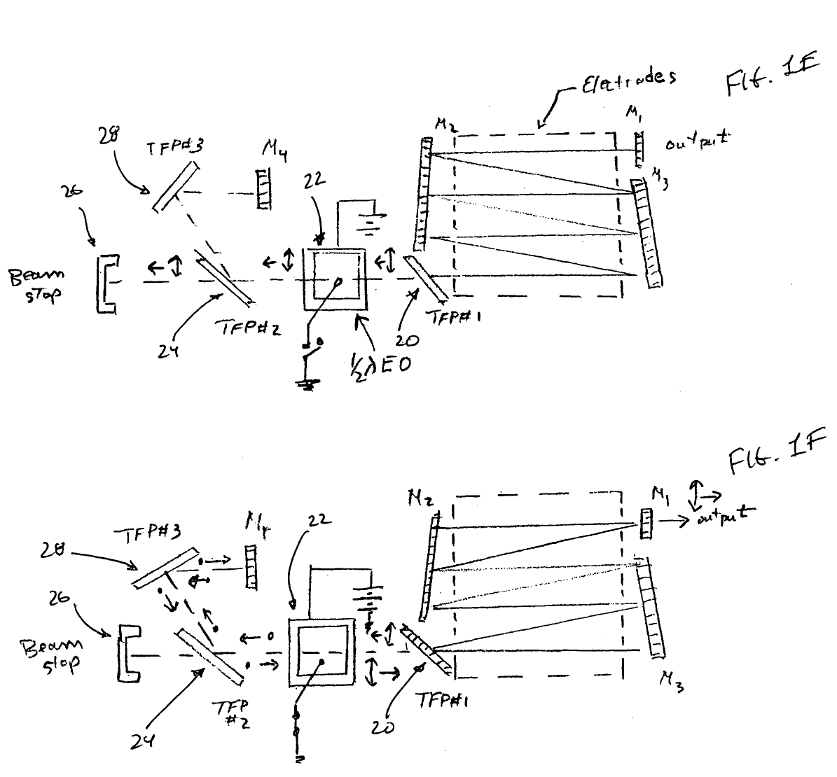

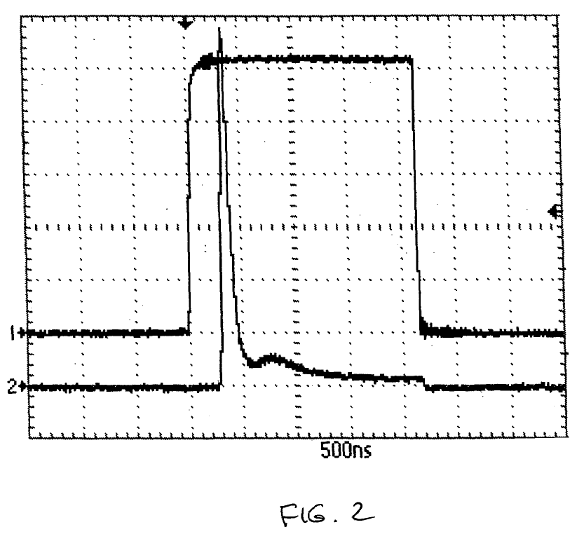

Referring to FIGS. 1A-1F, in one embodiment of the present invention, a first thin film polarizer (TFP) 10 is placed inside the laser cavity and serves as a window for the laser, thereby separating the atmosphere from the gas mixture within the laser heads. This first TFP 10 can be used to reinforce the normal polarization preference of the laser. The EO switch 12, followed by a second TFP 14, can be placed close to the first TFP 10, such as at a position next to the output window of the laser head. The second polarizer 14 is physically rotated 90° with respect to the first polarizer 10, as shown in FIG. 1A. For low pulse energy Q-switch lasers where the gain is lower, only the second TFP 14 need be used. For five or more waveguide folds, with each fold being approximately 50 cm long, for example, the gain can be so high that two or more TFPs are required to prevent oscillation and a subsequent leakage of laser radiation between Q-switched pulses. From an optical damage, beam quality, and cost viewpoint, a TFP/EO/TFP Q-switching module of the type illustrated is superior to the existing EO/RPR or the EO/Fresnel Rhomb Q-switching module approaches, particularly for higher average power and higher pulse energy Q-switched or cavity dumped lasers.

As stated above, FIGS. 1A-1F illustrate an exemplary laser arrangement in accordance with the concepts of the present invention.

FIG. 1A illustrates a high optical loss state for the laser. The optical electric field of the laser output radiation is aligned parallel to the surfaces of the opposing metal electrodes, or normal to the plane of FIG. 1A. This polarization passes through the first TFP 10, as shown in FIG. 1A, and into the half-wave CdTe EO switch 12. With the switch “S” in FIG. 1A open, there is no voltage applied to the EO modulator 12, such that the laser radiation passes through the modulator 12 with no polarization change and proceeds into the second ZnSe TFP 14. The second TFP 14 is physically rotated 90° as shown with respect to the first TFP 10. Consequently, radiation with the optical electric vector perpendicular to the plane of the paper is reflected out of the laser cavity and into a beam stop 16 by the second TFP 14. This high loss state prevents the laser from oscillating, thereby building up a large over-population in the upper laser level.

Once the over-population is maximized, the switch S is closed, as shown in FIG. 1B, thereby applying a half-wave voltage across the electrodes of the EO modulator 12. The radiation propagating through the CdTe modulator 12 then is rotated such that the optical electric field vector is parallel to the plane of the paper. This polarization propagates through the second TFP 14, and positive feedback occurs between the ZnSe output coupling mirror 18 (on the left in FIG. 1B) and the total reflecting mirror 20 (on the right in FIG. 1B). The rapid depletion of the over-population in the upper CO₂ laser level gives rise to the well known high peak power Q-switched laser pulse.

FIGS. 1C and 1D each illustrate a top view of an exemplary arrangement of a high damage threshold Q-switched CO₂ laser utilizing a half-wave EO modulator 22 and two TFPs 20, 24 in accordance with another embodiment of the invention. In this configuration, mirror M₁ is the output coupling mirror while mirrors M₂ and M₃ are the high reflecting folding mirrors of a five pass wave guide laser head. A first TFP 20 serves both as an output coupling mirror and as a polarizer, and mirror M₄ is the high reflective feedback mirror. The CdTe half-wave EO modulator 22 is inserted between the first TFP 20 and a second TFP 24, as shown.

The high loss state is obtained when the switch “S” is open, as shown in FIG. 1C. In this high loss state, radiation with a polarization in the plane of the paper propagates through the inactivated EO modulator 22 through the second TFP 24 and is absorbed by a laser beam stop 26, thereby preventing laser oscillation. When switch “S” is closed, as shown in FIG. 1D, the radiation leaving the EO modulator 22 is rotated 90, reflected by the second TFP 24, and directed to feedback mirror M₄, as shown in FIG. 1D. Mirror M₄ reflects the radiation back through the energized EO modulator 22. Consequently, the radiation is rotated another 90, bringing the radiation back to the original polarization that left the laser head. This is the low loss state whereby laser oscillation occurs and gives rise to a Q-switched laser pulse.

For high discharge excitation levels, or for long waveguide gain channels, a sufficiently high gain can be generated such that the gain is greater than the loss during the high loss state. Consequently, low power laser oscillation can occur between Q-switched pulses. This is known as leakage radiation. To eliminate this leakage radiation, the optical loss during the high loss state can be increased. One way to provide additional loss is to provide one or more additional TFPs within the laser feedback cavity, such as is illustrated in FIGS. 1E and 1F.

FIGS. 1E and 1F illustrate a seven waveguide pass laser discharge, as opposed to the five passes of FIGS. 1C and 1D, as well as the use of three TFPs (20, 24, 28) to prevent leakage during laser operation. The basic explanation of the working of this arrangement is essentially same as for the arrangement of FIGS. 1C and 1D. Another way to provide for additional loss is to utilize TFP coatings on both sides of one of the TFPs. This is a lower cost approach than using an additional TFP 28.

FIG. 2 provides experimental results obtained using an embodiment of the invention of the type shown in FIGS. 1C and 1D. The CO₂ laser discharge was energized by applying 100 MHz RF pulses to the electrodes. Each RF pulse had 2.5 KW of peak power and the RF pulse widths were 120 microseconds. The RF pulses were repeated at a 2.06 KHz rate. Only one RF pulse is shown in FIG. 2.

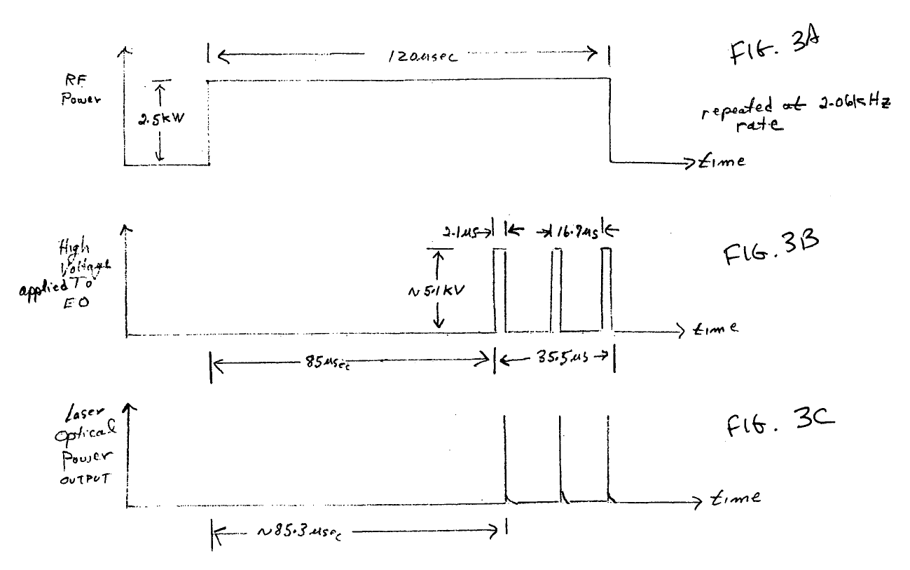

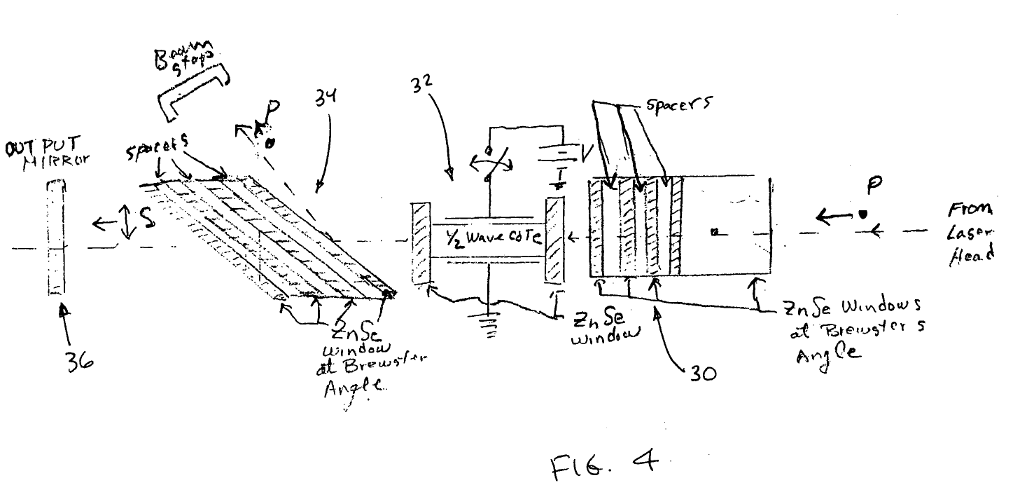

The upper oscilloscope trace “1” of FIG. 2 illustrates a square-wave high-voltage (˜5.1 KV) pulse lasting approximately 2.16 microseconds, as applied to a half-wave CdTe EO switch 22. The high voltage pulses were applied in a burst of 3 pulses, with each individual pulse separated by approximately 16.7 microseconds, or at a 60 KHz pulse repetition rate, as illustrated in FIG. 3A-3C. The first of these pulses was applied approximately 85 microseconds after the RF pulse was turned on. This delay enabled the over population in the upper laser level to build to an optimum value.

The lower trace “2” of FIG. 2 illustrates the oscilloscope trace of the emitted Q-switch pulse that occurred whenever the high voltage was applied to the EO modulator 22. The emission of the Q-switch laser pulse occurred approximately 300 nsec after the voltage was applied to the EO modulator 22.

Under the stated conditions, the Q-switched CO₂ waveguide laser used was a Coherent Model Q-1000. This laser has seven folded wave-guides having a gain length of approximately 350 cm. The laser emitted 25.3 Watts of average power under the stated conditions. This arrangement serves only as an example, as other variations of the mentioned parameters and timing sequences can be used within the scope of the present invention.

FIG. 3A shows a RF high voltage pulse that can be used to energize the discharge of the CO₂ laser. FIG. 3B illustrates three pulses applied to the EO modulator 22. FIG. 3C illustrates the three emitted Q-switched laser pulses as a function of time. FIGS. 3A-3C considered in combination show the relationships of the sequences with each other. It should be understood by those skilled in the art that a wide number of other timing sequences are also possible.

Since thin films on windows such as ZnSe windows (typical for CO₂ laser radiation) tend to have a lower optical damage threshold than the bulk optical material, the thin films tend to damage before bulk material when sufficiently high optical flux is passed through a TFP. To prevent polarizer thin-film coating damage on a ZnSe substrate at higher pulse energies and peak powers than are available in presently commercially available CO₂ Q-switched lasers, uncoated ZnSe windows can be used that are placed at approximately Brewster's angle instead of TFPs that utilize thin film coatings on ZnSe windows. The Brewster's angle for ZnSe occurs at approximately 67 degrees angle of incidence for the P-polarization. At this angle, the reflectivity of the S-polarization is approximately 49.2%, thereby allowing 50.8% of the incident P-polarization to be transmitted into the ZnSe material. At the ZnSe window exit surface, another 49.2% of the remaining 50.8% of the S-polarization that was transmitted into the material is reflected. This yields 25.8% of the incident S-polarization transmitted through the Brewster angle ZnSe polarizer, with approximately 75.2% being reflected.

In order to prevent an etalon effect with this Brewster angle ZnSe window polarizer approach, the two surfaces of the ZnSe plates/disks can be wedged slightly with respect to each other. The wedge angle can be only slightly larger than the diffraction angle of the collimated CO₂ laser beam. This angle is very small and can be easily accommodated.

In a similar manner, the percentage of incident S-polarized radiation propagating through a number of ZnSe plates (placed in tandem at Brewster angle with a small space separating them) also can be calculated. Table I below shows the result of such a calculation taking into account sides of one through four of ZnSe Brewster angle windows serving as polarizers.

TABLE I

| No. of | Total Transmitted S- | Total Reflected S- |
|---|---|---|
| ZnSe Brewster | Polarization at 10.6 | Polarization at 10.6 Microns |
| Angle Windows | Micron Radiation | From Both Surfaces |
| 1 | 0.26 | 0.74 |
| 2 | 0.07 | 0.93 |
| 3 | 0.02 | 0.98 |
| 4 | 0.01 | 0.99 |
| etc. | etc. | etc. |

It has been found that the Coherent Model Q-1000 Q-switched CO₂ lasers would not oscillate when approximately 3% or less of the radiation was allowed to propagate through the TFP/EO/TFP Q-switch module during the high optical loss portion of the Q-switch operation. Consequently, a minimum of three ZnSe Brewster's angle uncoated window polarizers would be needed to replace the thin-film polarizers in the Coherent model 1000 Q-switch laser. A Q-switched laser having a higher gain than the Q-1000 CO₂ model can require more than three Brewster's angle ZnSe windows to prevent the laser from oscillating during the high loss portion of the Q-switch process.

FIG. 4 illustrates an embodiment of the invention that utilizes two crossed Brewster angle, uncoated ZnSe window stacks 30, 34 with a half-wave CdTe EO switch 32 to obtain a higher optical damage threshold over the TPF/EO/TFP Q-switch modules described above. For simplicity, the laser is not shown. With the switch on the EO modulator 32 open, the P-polarization out of the laser propagates through the first ZnSe Brewster angle window polarizer stack 30, through the half-wave EO switch 32, and is reflected out of the laser cavity by the second ZnSe Brewster angle window polarizer stack 34. Consequently, the laser cannot oscillate and a large over population is obtained in the upper CO₂ molecule laser level.

When switch “S” is closed, voltage is applied to the half-wave EO switch 32 and the polarization is rotated such that radiation can pass through the second ZnSe Brewster angle window polarizer stack 34 and illuminate the output mirror 36. The output mirror 36, which can have a reflectivity selected for maximum laser output depending on the gain of the laser, can have a reflectivity of about 20 to 35%. The radiation can be fed back through the second polarizer stack 34, the half-wave EO switch 32, and the first polarizer stack 30, and directed into the laser gain region. After the Q-switched pulse is emitted, EO switch “S” is opened and the process can be repeated.

One disadvantage to using Brewster angle polarizers over a TPF is the added difficulty in aligning the laser cavity, due to the displacement of the laser radiation by the Brewster angle polarizers. Another disadvantage can be the use of multiple ZeSe windows, which can add significant cost. Consequently, such an approach may only be beneficial when the intensity of the radiation is high enough to cause optical damage to the TFPs.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A Q-switched CO₂ laser system comprising:
a plurality of mirrors defining an optical cavity;
a gain medium positioned within the optical cavity for generating laser beam radiation; and
a half-wave electro-optical modulator located within the optical cavity and including an optical crystal, the modulator operable to create a high loss state in the cavity when a first voltage is applied to the optical crystal and a low loss state when a second voltage is applied to the optical crystal.

2. A system according to claim 1, further comprising:
at least one insulator positioned around an exterior of the optical crystal to substantially prevent arcing and corona in the optical cavity.

3. A system as in claim 1, and wherein the optical crystal is a CdTe crystal.

4. A system as in claim 1, and further comprising:
at least one thin film polarizer positioned along a path of the laser beam radiation in the optical cavity.

5. A system as in claim 4, and wherein the modulator and the thin film polarizer are operable to shape an output pulse of the laser system.

6. A system as in claim 4, and wherein the modulator and the thin film polarizer are operable to direct alternate output pulses of the laser system along alternate paths.

7. A system as in claim 1, and further comprising:
a folded waveguide positioned along a path of the laser beam radiation in the optical cavity.

8. A system as in claim 1, and further comprising:
first and second thin film polarizers positioned along a path of the laser beam radiation in the optical cavity, the first and second thin film polarizers being positioned on opposing sides of the modulator.

9. A system as in claim 8, and wherein the first thin film polarizer functions as a window for the laser system.

10. A system as in claim 8, and wherein the first and second thin film polarizers are rotated 90° with respect to each other.

11. An active optical assembly receptive to a laser beam in a laser system, the assembly comprising:
a CdTe active optical crystal having an optical entrance surface and an opposing optical exit surface to be placed along a path of the laser beam;
a pair of electrodes positioned on opposite sides of the active optical crystal in order to apply a voltage across the optical crystal in a direction substantially orthogonal to the path of the laser beam through the optical crystal;
first and optical windows positioned adjacent the entrance and exit surfaces, respectively, along the path of the laser beam; and
at least one insulator positioned around a portion of the exterior of the optical crystal.

12. An assembly as in claim 11, and wherein the at least one insulator comprises a BeO ceramic.

13. An assembly as in claim 11, and further comprising:
a housing for supporting the first and second optical windows in physical contact with the optical crystal.

14. An assembly as in claim 11, and wherein the first and second optical windows comprise ZnSe.

15. An assembly as in claim 11, and wherein at least one of the first and second optical windows is uncoated.
